(19) United States
(12) Patent Application Publication
(10) Pub. No.: US 2004/0180788 A1
(43) Pub. Date: Sep. 16, 2004

(54) Synthesizing carbon-based adsorbents for mercury removal

(76) Inventors: Nasrin R. Khalili, Evanston, IL (US); Victor Hugo Perez-Luna, Naperville, IL (US)

Correspondence Address: PAULEY PETERSEN & ERICKSON, 2800 WEST HIGGINS ROAD, SUITE 365, HOFFMAN ESTATES, IL, 60195, US

(21) Appl. No.: 10/385,351

(22) Filed: Mar. 10, 2003

(51) Int. Cl. B01J 20/20

(52) U.S. Cl. 502/417; 423/210

(57) ABSTRACT

A method for preparing an adsorbent composition for removal of mercury from an environment. A quantity of activated carbon is treated with a protein having a net negative charge to obtain a negative surface charge. Gold is plated on a treated portion of the quantity of activated carbon to form an adsorbent for the removal of mercury. The gold is plated on the activated carbon by electroless gold plating. The electroless gold plating includes adsorbing tin ions onto the treated portion of the quantity of activated carbon, adsorbing silver atoms onto the adsorbed tin, and substituting gold atoms for the adsorbed silver. The gold forms a chemical amalgam with mercury and thereby can be used to remove mercury from industrial emissions.

### FIELD OF THE INVENTION

This invention relates generally to a process for providing carbon-based adsorbents, particularly gold plated activated carbon, for the removal of mercury from an environment, such as from industrial emissions.

### BACKGROUND OF THE INVENTION

Activated carbon is a frequently used adsorbent material and has virtually displaced many other materials in use as adsorbents in various recovery systems. Activated carbon is a generally superior adsorbent at least in part because of desirable surface properties. The unique adsorption capability of activated carbon is generally related to such carbon materials having a high adsorption capacity and a high degree of surface porosity and such as may relate to carbon materials desirably having relatively high surface areas and significant microporous structure.

Activated carbon is used extensively for or in various industrial applications including: solvent recovery, gas refining, air purification, exhaust desulfurization, deodorization and gas separation and recovery, for example. The application of activated carbon in water treatment includes: removal of color, odor, taste or other undesirable impurities from water; treatment of domestic and industrial wastewaters; and collection and recovery of solutes. In addition, activated carbon has found application as catalysts in various chemical processes.

Emissions from fossil fuel combustion, such as in coal burning power plants, and waste combustion typically include compounds such as oxygen, hydrogen disulfide, carbon dioxide, carbon monoxide, hydrochloric acid, chlorine, as well as sulphur and nitrogen containing compounds. Heavy metals, such as mercury in the form of mercury vapor, are also typically present in such combustion flue gases, particularly from coal-burning power plants. Mercury emissions from a typical 500 megawatt power plant have been shown to be as much as 500 pounds per year. The release of mercury into the atmosphere is undesirable, and recent regulations have been enacted to restrict the release of mercury into the environment through industrial emissions.

Mercury can be absorbed through the skin or inhaled in vapor form. The effects of mercury poisoning are cumulative, and mercury can do considerable damage if untreated over a long period of time. Therefore, removing mercury from combustion emissions is beneficial, and particular attention has been given to provide low cost, efficient methods for mercury removal.

Various metals, and particularly noble metals such as gold, silver, copper, palladium, and platinum, are known to form an amalgamation with mercury. These materials can thus be used to react with, and remove mercury from an environment, such as a flue gas stream from a coal burning plant.

U.S. Pat. No. 3,193,987, issued to Manes et al., discloses a mercury removal composition including activated carbon impregnated with a solution of a reducible salt of various metals including gold, silver, and copper. The solution is dried leaving the salt on the surface of the activated carbon, and the metal salt is reduced by heating to form the free metal. U.S. Pat. No. 5,409,522 issued to Durham et al., and U.S. Pat. No. 6,136,281 issued to Meischen et al. disclose similar methods of impregnating activated carbon with a solution containing the reducible salt of a metal, followed by evaporating the solvent and reducing the salt to the free metal through heating.

Impregnation of activated carbon by processes using a solution containing the reducible salt of a noble metal, such as gold or silver, typically requires relatively complex production processes and facilities, which can increase the cost of the produced adsorbent. In addition, such impregnation processes generally require large amounts of the noble metal to obtain the desired add-on level, which also results in a high production cost. Gold add-on, for example, is also generally more difficult to control using impregnation processes, particularly as compared with the processes of this invention.

There is a need for a low cost, effective adsorbent for the removal of mercury vapor from an environment, particularly from flue gas emissions from industrial or power plants. There is also a need for a reusable adsorbent for the removal of mercury vapor. In particular, there is a need for an activated carbon based adsorbent plated with amounts of gold which would provide efficient, effective, and low cost mercury vapor removal from an environment.

### SUMMARY OF THE INVENTION

A general object of the invention is to provide a composition for removal of mercury vapor from an environment.

A more specific objective of the invention is to overcome one or more of the problems described above.

The general object of the invention can be attained, at least in part, by a method for preparing an adsorbent composition for removal of mercury from an environment. In one embodiment of this invention, the method includes providing a quantity of activated carbon. At least a portion of the quantity of activated carbon is treated to obtain a negative surface charge on at least a treated portion of the quantity of activated carbon. Gold is then plated on at least a portion of the treated portion of the quantity of activated carbon to form an adsorbent for the removal of mercury.

The activated carbon can be treated with a molecule, such as a protein, having a net negative charge to obtain a negative surface charge. The method of this invention can coat any surface of the activated carbon, including both an outer surface of an activated carbon particle and surfaces within the pore structure. Gold is plated on the treated portion of the quantity of activated carbon by electroless gold plating. The electroless gold plating includes adsorbing tin ions onto at least a portion of the treated portion of the quantity of activated carbon, adsorbing silver atoms onto at least a portion of the adsorbed tin, and substituting gold atoms for at least a portion of the adsorbed silver.

The invention provides a method for the removal of mercury vapor from an environment by treating at least a portion of a surface of a quantity of activated carbon by adsorption of a protein to form a quantity of treated activated carbon and plating gold onto at least a portion of the treated portion of the quantity of treated activated carbon to form a quantity of gold plated activated carbon. The quantity of gold plated activated carbon is introduced into an environment containing mercury vapor. At least a portion of the mercury vapor forms a chemical amalgam with at least a portion of the gold of the gold plated activated carbon to form a quantity of amalgam coated activated carbon. By removing at least a portion of the quantity of amalgam coated activated carbon from the environment, at least a portion of the mercury vapor is also removed from the environment.

The invention thus relates to a composition including a quantity of activated carbon having a plurality of molecules having a net negative charge bonded to at least a portion of a surface of the quantity of activated carbon, and gold plated on at least a portion of a surface of the quantity of activated carbon. In one embodiment of the invention, the plurality of molecules having a net negative charge include a plurality of protein molecules, such as bovine serum albumin.

Other objects and advantages will be apparent to those skilled in the art from the following detailed description taken in conjunction with the appended claims and drawings.

### BRIEF DESCRIPTION OF THE DRAWINGS

FIG. 1 is a photograph of a particle of gold plated activated carbon, described below in the Example section, taken with a scanning electron microscope (SEM).

FIG. 2 is a graph of mercury removal efficiency of a quantity of gold plated activated carbon according to one embodiment of this invention described in the Example section below.

### DETAILED DESCRIPTION OF THE PRESENTLY PREFERRED EMBODIMENTS

The present invention generally relates to a method for providing an adsorbent for the removal of environmental pollutants from an environment. More particularly, the invention relates to a gold plated activated carbon adsorbent and a method for providing the gold plated carbon adsorbent. The invention also relates to a gold plated activated carbon adsorbent for the removal of mercury vapor, such as from an industrial flue gas stream.

In one embodiment of this invention, a method for providing an adsorbent for the removal of mercury includes providing a quantity of activated carbon. The quantity of activated carbon can include a single piece or particle of activated carbon or a plurality of pieces or particles of activated carbon. As will be appreciated by one skilled in the art, the methods of this invention are not dependent on any particular size, shape, or number of the individual particle or particles of activated carbon. In one embodiment of this invention, the quantity of activated carbon includes a plurality of particles having a surface area of about 600 meters²/gram to about 1,700 meters²/gram, and more desirably about 1,100 meters²/gram to about 1,300 meters²/gram. As used herein unless otherwise denoted, the “surface” of the activated carbon refers to all surfaces of the activated carbon, including the surfaces within the pore structure of the activated carbon.

Activated carbon is generally a porous material. The pores of activated carbon increase the surface area of the activated carbon, which increases the adsorbent properties of the activated carbon. In general, pores are classified by size in one of three categories or classes: mieropores (pores having a width less than 2 nanometers), mesopores (pores having a width of 2 nanometers to 50 nanometers), and macropores (pores having a width in excess of 50 nanometers). The adsorbents of this invention can be produced using activated carbon having any pore size. In one embodiment of this invention, the quantity of activated carbon comprises a plurality of pores having a diameter of about 100 nanometers to about 1,000 nanometers. Larger pores result in a smaller surface area but allow for adsorption of larger mercury vapor particles within the pore structure.

Processes for producing activated carbon are generally known in the art. One such process, disclosed in U.S. Pat. No. 6,030,922, issued to Khalili et al. on 29 Feb. 2000 and entitled Synthesizing Carbon From Sludge, herein incorporated by reference, produces activated carbon from carbonaceous wastewater sludge. By controlling the method of production of activated carbon, for example, by varying amounts of activating agents used, extending the duration of surface activation, and the addition of a purification process, it is possible to control the pore structure and produce quantities of activated carbon having a desired high surface area.

Activated carbon typically has a graphite-like structure and is highly hydrophobic. It has been discovered that by modifying the surface chemistry of activated carbon to obtain a negative charge, gold can be plated onto the outer surface and on surfaces within the pore structure of activated carbon. The addition of gold on the outer surface and on surfaces within the pore structure provides an effective and efficient adsorbent for elemental mercury, such as mercury vapor from industrial flue gas.

In one embodiment of this invention, the quantity of activated carbon is cleaned before the surface is modified. Cleaning typically enhances pore size and purity by removing contaminants, such as dirt and other organic and inorganic contaminants. The activated carbon can be cleaned using a combination of water, methanol, and dilute hydrochloric acid. In one embodiment of this invention, 1.0 gram of activated carbon is cleaned by first mixing the activated carbon to 50 milliliters of distilled water and washing for 10 minutes. Next, the activated carbon is mixed with 50 milliliters of 25 percent methanol for 10 minutes to remove organic contaminants. The activated carbon is then mixed with 50 milliliters of 0.1 moles/liter hydrochloric acid for 10 minutes to remove inorganic contamination.

At least a portion of the quantity of activated carbon is treated to obtain a negative surface charge on a treated portion of the quantity of activated carbon. The quantity of activated carbon can be treated by contacting the activated carbon with a solution containing a plurality of molecules possessing a net negative charge. The molecules possessing a net negative charge adsorb onto the surface of activated carbon due to hydrophobic interactions between the hydrophobic surface of the activated carbon and hydrophobic functional or chemical groups of the molecules possessing a net negative charge. The molecules possessing a net negative charge adsorb onto at least a portion of the activated carbon, resulting in a treated portion of the quantity of activated carbon. The net negative charge of the molecules cause the generally hydrophobic surface of the activated carbon to become hydrophilic.

Desirably, the entire surface area of the quantity of activated carbon is treated with molecules possessing a net negative charge, however, due to the random nature of the adsorption reactions in solution, typically only a portion of the surface of quantity of activated carbon is treated. The size of the treated portion of the quantity of activated carbon is generally dependent on factors including the amount and surface area of activated carbon, the amount of molecules having a net negative charge in the solution, the time the activated carbon is in contact with the solution, and the chemical nature of the molecule having a net negative charge.

In one embodiment of this invention, the molecule possessing a net negative charge is a protein, and in one embodiment, a protein possessing a net negative charge. Without intending to be bound by theory, the protein adsorbs on the surface of the activated carbon due to hydrophobic interactions between hydrophobic portions of the protein and the surface of the activated carbon. The multipoint attachment nature of many protein molecules can provide an almost irreversible bond with the activated carbon. The amino terminus and the carboxyl terminus of a protein provide a treated activated carbon surface capable of adsorbing, for example, tin ions and silver ions effectively, for use in gold plating by an oxidation-reduction reaction.

One preferred protein possessing a net negative charge for use in the method of this invention is bovine serum albumin, however, the invention is not limited to any particular protein which possesses a negative charge. Bovine serum albumin (BSA) is a globular protein having a measured isoelectric point of about 4.6 to 4.8, and thus has a net negative charge at neutral and physiological pH. Advantages of using proteins possessing a net negative charge, and particularly bovine serum albumin, for treating the quantity of activated carbon include the relatively low cost, as well as the availability, of proteins. The quantity of activated carbon can be treated with a solution containing the protein, such as a bovine serum albumin solution having a concentration of 5.0 milligrams protein/milliliter water. The amount of adsorbed protein can be determined by weighing the quantity of activated carbon before treating and again weighing the activated carbon after treating (when dried) and determining the difference.

Gold is then plated on at least a portion of the treated portion of the quantity of activated carbon to form an adsorbent for the removal of mercury. The gold plates to at least a portion of the plurality of molecule possessing a net negative charge. The gold can be plated on the treated portion by various gold plating techniques known in the art.

In one embodiment of this invention, the gold is plated on at least a portion of the treated portion of the quantity of activated carbon by electroless gold plating. Electroless gold plating involves the use of a chemical reducing agent to plate a metal, such as gold, from solution onto a surface. The use of electroless gold plating methods in this invention are desirable as electroless gold plating does not require the surface being coated to be electrically conductive. However, the invention is not intended to be limited to electroless gold plating, as other gold plating methods may be used to coat the treated activated carbon.

In one embodiment of this invention, the electroless gold plating includes applying a sensitizer, such as tin(II) ions (Sn⁺²), to the surface of the treated portion of the quantity of activated carbon. The tin(II) sensitizer can be applied by immersing the quantity of activated carbon in a solution including tin(II)chloride (SnCl₂) and trifluoroacetic acid in a solvent of 50% methanol and 50% water. The activated carbon is then removed from the solution and rinsed with methanol. The tin ions (Sn⁺²) adsorb to the treated portion of the quantity of activated carbon by bonding to at least a portion of the molecules possessing the net negative charge.

The tin ion sensitized treated portion of the activated carbon is activated by immersing the quantity of activated carbon in an aqueous solution of silver nitrate (AgNO₃). In solution, silver ions react with the tin ions in an oxidation-reduction reaction, resulting in the oxidation of the tin(II) ions to tin(IV) ions (Sn⁺⁴) and the reduction of silver ions (Ag⁺¹) to elemental silver atoms (Ag⁰). The electrochemical reaction between the tin ions and the silver ions results in the reduced silver atoms adsorbing onto, and coating, at least a portion of the treated portion of the activated carbon. After silver atom deposition, the activated carbon is removed from the solution and rinsed with a 50/50 solution of methanol and water.

The silver coated activated carbon is immersed in a gold plating solution including trisodium gold sulfide (Na₃Au(SO₃)), disodium sulfide (Na₂SO₃), and formaldehyde at a relatively low solution temperature as known in the art, for example, at about 2° C. In the solution, at least a portion of the silver atoms adsorbed onto the treated portion of the activated carbon are substituted with gold atoms. The gold atoms substitute for the silver atoms because the silver present on the surface of the activated carbon acts as a catalyst promoting oxidation-reduction reactions, which result in electroless deposition of reduced gold from the solution onto the surface of the activated carbon. The formaldehyde acts as a reducing agent to reduce the gold ions (Au⁺¹) to elemental gold atoms (Au⁰). The activated carbon is removed from the gold plating solution and can be rinsed with 25% nitric acid (HNO₃) to remove any tin or silver residue.

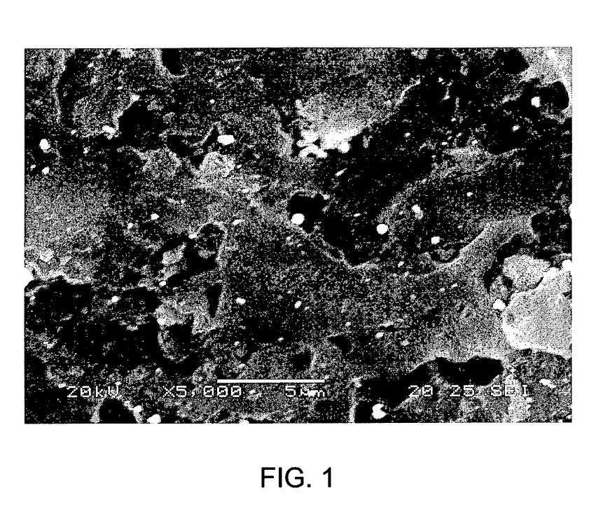

The methods of this invention thus provides an adsorbent composition which is useful for the removal of mercury from an environment. FIG. 1 is a photograph of gold plated activated carbon obtained according to a method described below. The gold plated activated carbon includes a quantity of activated carbon and a plurality of molecules having a net negative charge bonded to at least a portion of a surface of the quantity of activated carbon, and gold plated on at least a portion of a surface of the quantity of activated carbon. In one embodiment of this invention, tin ions are bonded to at least a portion of the plurality of molecules having a net negative charge and the gold atoms are plated onto the surface of the activated carbon. The methods of this invention allow plating of gold on an outer surface of the activated carbon particles as well as on surfaces within the pore structure, i.e., on the inner surface of the pores, of the activated carbon. The gold plated activated carbon provided by the method described above is an effective and efficient adsorbent of mercury.

The gold plated activated carbon obtained by the methods of this invention described above can be used to remove mercury vapor from an environment. In one embodiment of this invention, a quantity of gold plated activated carbon is introduced into an environment including mercury vapor, such as in an emissions system in an industrial plant. The mercury vapor present in the environment forms a chemical amalgam with the gold of the gold plated activated carbon to form a quantity of amalgam coated activated carbon. Mercury removal is accomplished by removing the quantity of amalgam coated activated carbon from the environment.

The mercury adsorbent composition of this invention is reusable in that the mercury can be removed from the gold mercury amalgam of the amalgam coated activated carbon. The gold plated activated carbon can then be reused to remove additional mercury from the same or a different environment. The ability to remove the mercury from the amalgam coated activated carbon and reuse the gold plated activated carbon lowers the overall costs of removing mercury from an environment. The mercury can be removed from the amalgam coated activated carbon by heating the amalgam coated activated carbon to temperatures near the boiling point of mercury, providing an amount of distilled mercury.

### EXAMPLE

To demonstrate the mercury removal properties of the adsorbents of this invention, a quantity of gold plated activated carbon was made by the following process. A 1.0 gram quantity of activated carbon particles having a surface area of about 1,207 meters²/gram, a micropore area of about 982 meters²/gram and a micropore volume of about 0.79 cubic centimeters/gram, were first cleaned by immersion in 50 milliliters of distilled water for 10 minutes, followed by immersion in 50 milliliters of 25 percent methanol for 10 minutes, and finally immersion in 50 milliliters of 0.1 moles/liter hydrochloric acid for 10 minutes. The surface area, pore area, and pore volume of the quantity of activated carbon was determined by BET analysis, using a Coulterm™ SA 3100™ nitrogen gas BET analyzer, available from Beckman Coulter.

The activated carbon was treated with bovine serum albumin by immersing the 1.0 gram quantity of activated carbon in a 50 milliliter solution of 5.0 milligram/milliliter bovine serum albumin for about 120 minutes. The protein treated activated carbon was then gold plated by electroless gold plating. The treated activated carbon was sensitized by immersing the treated activated carbon in a 50 milliliter solution including a solvent of 50% methanol and 50% water and 0.026 moles/liter tin(II)chloride (SnCl₂) and 0.07 moles/liter trifluroacetic acid, for 5.0 minutes. Silver was deposited on the treated portions of the activated carbon by immersing the sensitized activated carbon in a 0.029 moles/liter silver nitrate (AgNO₃) solution for 5.0 minutes. Immersing the silver coated activated carbon in 50 milliliters of gold plating solution containing 7.9×10⁻³ moles/liter trisodium gold sulfide (Na₃Au(SO₃)), 0.127 moles/liter disodium sulfide (Na₂SO₃), and 0.625 moles/liter formaldehyde at a solution temperature of 2° C. for 24 hours, substituted gold atoms for the silver atoms. The gold plated activated carbon was immersed in 25% nitric acid (HNO₃) for 12 hours to rinse the activated carbon of any remaining tin or silver residue. FIG. 1 shows a SEM photograph of a portion of one particle of the quantity of activated carbon made by the process described above.

The mercury removal properties of the above prepared quantity of gold plated activated carbon were tested by introducing a 0.1 gram quantity of the gold plated activated carbon into a stream of mercury containing flue gas. The approximate makeup of the stream of flue gas was controlled by mass flow controllers for each component, and included nitrogen as a base carrier gas with about 6% by weight oxygen, about 12% by weight carbon dioxide, about 8% by weight water vapor, and about 8000 nanogram/meter³ mercury vapor. The flue gas stream had a flow rate of 1.0 meters³/minute. The 0.1 gram quantity of activated carbon was contained in a chamber having a 0.25 inch (0.635 centimeter) diameter and a length of 20 inches (50.8 centimeters) in combination with a flue gas piping system. The flue gas piping system also included a bypass pipe to direct the flue gas stream around, and not in contact with, the chamber containing the gold plated activated carbon, for comparative testing. Mercury vapor was generated using a permeation tube having an emission rate range of about 8,000 to 10,000 nanograms/meter³ at 100° C. An oil bath was used to maintain a constant temperature for generation of mercury vapor. A mercury analyzer, available from OhioLumex Co., Twinsburg, Ohio, was used to measure the presence of mercury in the flue gas stream.

To obtain a baseline measurement, a flue gas stream as described above only not containing any mercury was released through the bypass and into the mercury vapor detector for 3.0 minutes. At 3.0 minutes, the mercury containing flue gas stream was released through the bypass and in contact with the mercury vapor detector for 8.0 minutes. At 8.0 minutes, the bypass was closed and the mercury containing gas stream was directed to the detector through the gold plated activated carbon for 11.0 minutes. At 11.0 minutes, the bypass was reopened and the mercury containing flue gas stream was again directed away from the gold plated activated carbon and to the detector or an additional seven minutes.

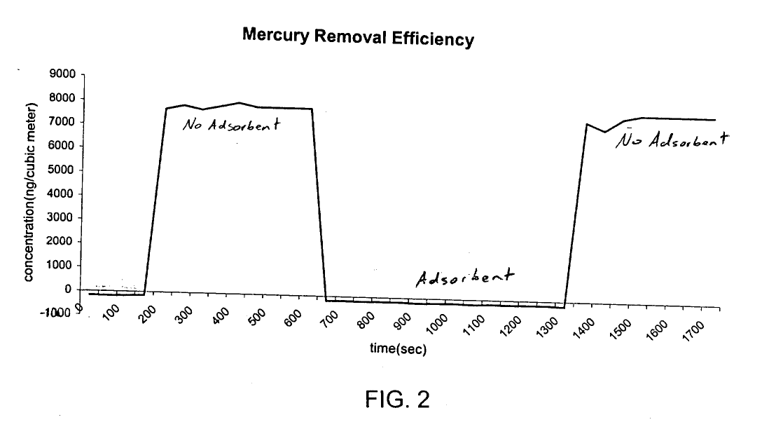

FIG. 2 is a graph of the mercury concentration in the flue gas stream measured during the testing. When the mercury containing flue gas stream bypassed the gold plated activated carbon, the mercury concentration was measured at approximately 8000 nanogram/meter³.

As shown in FIG. 2, the gold plated activated carbon was able to remove 100 percent of the mercury present in the flue gas stream. Thus, the methods of this invention provide an efficient carbon-based adsorbent for removal of mercury.

It is to be understood that the discussion of theory, such as the discussion of the specific mechanisms of the chemical reactions of any adsorption, bonding, or plating, for example, are included to assist in the understanding of the subject invention and are in no way limiting to the invention in its broader application.

While the embodiments of the invention described herein are presently preferred, various modifications and improvements can be made without departing from the spirit and scope of the invention. The scope of the invention is indicated by the appended claims, and all changes that fall within the meaning and range of equivalents are intended to be embraced therein.

What is claimed is:

1. A method for providing an adsorbent for the removal of mercury, comprising:
providing a quantity of activated carbon;
treating at least a portion of the quantity of activated carbon to obtain a negative surface charge on at least a treated portion of the quantity of activated carbon; and
plating gold on at least a portion of the treated portion of the quantity of activated carbon to form the adsorbent for the removal of mercury.

2. The method of claim 1, wherein the treating of at least a portion of the quantity of activated carbon includes adsorption of a plurality of molecules possessing a net negative charge.

3. The method of claim 2, wherein the molecules possessing a net negative charge include a protein.

4. The method of claim 3, wherein the protein is bovine serum albumin.

5. The method of claim 1, wherein the gold is plated on at least a portion of the treated portion of the quantity of activated carbon by electroless gold plating.

6. The method of claim 5, wherein the electroless gold plating comprises the steps of.
adsorbing tin ions onto at least a portion of the treated portion of the quantity of activated carbon;
adsorbing silver atoms onto at least a portion of the adsorbed tin; and
substituting gold atoms for at least a portion of the adsorbed silver.

7. The method of claim 6, wherein the treating of at least a portion of the quantity of activated carbon includes adsorption of a plurality of molecules possessing a net negative charge and the tin ions bond to at least a portion of the plurality of molecules possessing a net negative charge.

8. The method of claim 6, wherein the adsorption of silver atoms onto at least a portion of the adsorbed tin ions includes oxidation of the tin ions.

9. The method of claim 1, wherein the quantity of activated carbon comprises a plurality of particles having a surface area of about 600 meters²/gram to about 1,700 meters²/gram.

10. The method of claim 9, wherein the quantity of activated carbon comprises a plurality of particles having a surface area of about 1,100 meters²/gram to about 1,300 meters²/gram.

11. A method for the removal of mercury vapor from an environment, comprising:
treating at least a portion of a surface of a quantity of activated carbon by adsorption of a plurality of protein molecules to form a quantity of treated activated carbon;
plating gold onto at least a portion of the treated portion of the quantity of treated activated carbon to form a quantity of gold plated activated carbon;
introducing the quantity of gold plated activated carbon into an environment including mercury vapor, wherein at least a portion of the mercury vapor forms a chemical amalgam with at least a portion of the gold of the of gold plated activated carbon to form a quantity of amalgam coated activated carbon; and
removing at least a portion of the quantity of amalgam coated activated carbon from the environment effective to remove at least a portion of the mercury vapor from the environment.

12. The method of claim 11, further comprising removing at least a portion of the mercury from the quantity of amalgam coated activated carbon.

13. The method of claim 12, wherein the mercury is removed by heating from the quantity of amalgam coated activated carbon.

14. The method of claim 11, wherein the plurality of protein molecules include bovine serum albumin.

15. The method of claim 11, wherein the gold is plated onto the treated portions of the quantity of treated activated carbon by electroless gold plating.

16. A composition, comprising:
a quantity of activated carbon;
a plurality of molecules having a net negative charge bonded to at least a portion of a surface of the quantity of activated carbon; and
gold plated on at least a portion of a surface of the quantity of activated carbon.

17. The composition of claim 16, wherein the plurality of molecules having a net negative charge includes a plurality of protein molecules.

18. The composition of claim 17, wherein the plurality of protein molecules includes bovine serum albumin.

19. The composition of claim 16, further comprising tin ions bonded to at least a portion of the plurality of molecules having a net negative charge.

20. The composition of claim 16, wherein the quantity of activated carbon comprises particles having a surface area of about 600 meters²/gram to about 1,700 meters²/gram.

21. The composition of claim 16, wherein the quantity of activated carbon comprises a plurality of pores having a diameter of about 100 nanometers to about 1,000 nanometers.
